(19) United States
(12) Patent Application Publication
(10) Pub. No.: US 2007/0134602 A1
(43) Pub. Date: Jun. 14, 2007

(54) HIGH-PRESSURE PROCESSING APPARATUS

(76) Inventors: Kenji Matsumoto, Nirasaki-shi (JP); Takayuki Komiya, Nirasaki-shi (JP); Eiichi Kondoh, Kofu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/610,131

(22) Filed: Dec. 13, 2006

(30) Foreign Application Priority Data
Dec. 14, 2005 (JP) 2005-360794

(51) Int. Cl. G03C 5/16

(52) U.S. Cl. 430/348

(57) ABSTRACT

A high-pressure processing apparatus is used for performing a film formation process on a target object, while using a process fluid containing a high-pressure fluid and a film formation source material. The apparatus includes a pressure tight container defining a process field for accommodating the target object, and configured to withstand a pressure applied from the high-pressure fluid. The pressure tight container is made of a first material. A support member is disposed inside the pressure tight container to support the target object. A fluid supply system is configured to supply the process fluid onto the target object. A thermally shielding layer is disposed to cover a surface of the pressure tight container defining the process field. The thermally shielding layer is made of a second material having a thermal conductivity higher than that of the first material.

### CROSS-REFERENCE TO RELATED APPLICATIONS

This application is based upon and claims the benefit of priority from prior Japanese Patent Application No. 2005-360794, filed Dec. 14, 2005, the entire contents of which are incorporated herein by reference.

### BACKGROUND OF THE INVENTION

1. Field of the Invention

The present invention relates to a high-pressure processing apparatus for processing a target object, such as a semiconductor wafer, while using a process fluid containing a high-pressure fluid, such as a supercritical fluid, and a film formation source material, and particularly to an improvement of a semiconductor processing technique. The term “semiconductor process” used herein includes various kinds of processes which are performed to manufacture a semiconductor device or a structure having wiring layers, electrodes, and the like to be connected to a semiconductor device, on a target object, such as a semiconductor wafer or a glass substrate used for an FPD (Flat Panel Display), e.g., an LCD (Liquid Crystal Display), by forming semiconductor layers, insulating layers, and conductive layers in predetermined patterns on the target object.

2. Description of the Related Art

Along with an increase in the integration of semiconductor devices, techniques for forming an interconnection line are being developed to embed an interconnection line material in a minute pattern with a high aspect ratio. As one of the techniques of this kind, there has been proposed a method for forming a film for a minute pattern, while using a supercritical fluid as a medium for a film formation source material. For example, where a copper (Cu) interconnection line is formed, a process fluid is prepared by dissolving a precursor, such as an organic complex compound containing Cu (precursor compound), into carbon dioxide in a supercritical state, and further adding thereto a reducing agent, such as hydrogen. The process fluid thus prepared is supplied onto the surface of a semiconductor wafer (which may be simply referred to as “wafer” as well, hereinafter) to perform Cu film formation.

The supercritical state is a state where a substance has properties of both of gas and liquid at a temperature and a pressure higher than certain values inherent to the substance (critical points). Where a substance in a supercritical state is used as a medium, since it has a density and dissolving property close to those of liquid, the solubility of a precursor can be set higher than a case where gas is used as a medium. Further, since it also provides a diffusion coefficient close to gas, the precursor can be carried onto a wafer more efficiently than a case where liquid is used as a medium. Consequently, where a process fluid prepared by dissolving a precursor into a medium in a supercritical state is used for film formation, the film formation can be performed with a high film formation rate and good coverage for minute patterns (for example, Jpn. Pat. Appln. KOKAI Publication No. 2005-187879 (FIG. 1, paragraph number 0018, and paragraph number 0019: Patent Document 1)).

### BRIEF SUMMARY OF THE INVENTION

An object of the present invention is to provide a high-pressure processing apparatus suitable for performing a film formation process, while using a process fluid containing a high-pressure fluid, such as a supercritical fluid, and a film formation source material.

According to a first aspect of the present invention, there is provided a high-pressure processing apparatus for performing a film formation process on a target object, while using a process fluid containing a high-pressure fluid and a film formation source material, the apparatus comprising:

a pressure tight container defining a process field for accommodating the target object, and configured to withstand a pressure applied from the high-pressure fluid, the pressure tight container being made of a first material;

a support member disposed inside the pressure tight container to support the target object;

a fluid supply system configured to supply the process fluid onto the target object; and

a thermally shielding layer disposed to cover a surface of the pressure tight container defining the process field, the thermally shielding layer being made of a second material having a thermal conductivity higher than that of the first material.

According to a second aspect of the present invention, there is provided a high-pressure processing apparatus for performing a film formation process on a target object, while using a process fluid containing a high-pressure fluid and a film formation source material, the apparatus comprising:

a pressure tight container defining a process field for accommodating the target object, and configured to withstand a pressure applied from the high-pressure fluid, the pressure tight container being made of a first material having a thermal conductivity of 10 to 100 W/mK at 100° C.;

a support member disposed inside the pressure tight container to support the target object;

a fluid supply system configured to supply the process fluid onto the target object; and

a thermally shielding layer disposed to cover a surface of the pressure tight container defining the process field, the thermally shielding layer being made of a second material having a thermal conductivity of higher than 100 W/mK at 100° C.,

wherein the thermally shielding layer is disposed to cover substantially entirely an upper inner surface of the pressure tight container, and includes a sidewall portion extending downward from an entire periphery thereof to cover a side surface of the pressure tight container, and

wherein the fluid supply system is arranged such that the process fluid flows through an opening located at a bottom end of the sidewall portion and is then supplied onto the target object supported by the support member.

According to a third aspect of the present invention, there is provided a high-pressure processing apparatus for performing a film formation process on a target object, while using a process fluid containing a high-pressure fluid and a film formation source material, the apparatus comprising:

a pressure tight container defining a process field for accommodating the target object, and configured to withstand a pressure applied from the high-pressure fluid, the pressure tight container being made of a first material having a thermal conductivity of 10 to 100 W/mK at 100° C.;

a support member disposed inside the pressure tight container to support the target object;

a fluid supply system configured to supply the process fluid onto the target object; and

a thermally shielding layer disposed to cover a surface of the pressure tight container defining the process field, the thermally shielding layer being made of a second material having a thermal conductivity of higher than 100 W/mK at 100° C.,

wherein the thermally shielding layer is disposed to cover substantially entirely an upper inner surface of the pressure tight container, and

wherein the fluid supply system comprises a fluid supply head formed behind the thermally shielding layer, and a plurality of spouting holes formed in the thermally shielding layer and communicating with the fluid supply head.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view showing a high-pressure processing apparatus according to a first embodiment of the present invention;

FIG. 2 is a plan view schematically showing a worktable used in the high-pressure processing apparatus shown in FIG. 1;

FIG. 3 is a perspective view schematically showing a thermally shielding layer used in the high-pressure processing apparatus shown in FIG. 1;

FIGS. 4A, 4B, and 4C are sectional views showing sequentially ordered steps of a process performed in the high-pressure processing apparatus shown in FIG. 1;

FIGS. 5A, 5B, and 5C are sectional views showing sequentially ordered steps of a process performed in the high-pressure processing apparatus shown in FIG. 1;

FIG. 6 is a flowchart showing sequentially ordered steps of a process performed in the high-pressure processing apparatus shown in FIG. 1;

FIG. 7 is a sectional view showing a high-pressure processing apparatus according to a second embodiment of the present invention;

FIG. 8 is a perspective and exploded view schematically showing a showerhead used in the high-pressure processing apparatus shown in FIG. 7;

FIG. 9 is a sectional view showing a high-pressure processing apparatus according to a third embodiment of the present invention;

FIG. 10 is a perspective view schematically showing a heat sink layer used in the high-pressure processing apparatus shown in FIG. 9;

FIG. 11 is an explanatory view schematically showing a high-pressure processing system including a high-pressure processing apparatus; and

FIG. 12 is a graph showing the relationship between the temperature of the inner wall of a process chamber and the thickness of a Cu film formed on the surface of a wafer, obtained by an experiment.

### DETAILED DESCRIPTION OF THE INVENTION

In the process of developing the present invention, the inventors studied problems caused in high-pressure processes using a process fluid containing a high-pressure fluid, such as a supercritical fluid, and a film formation source material. As a result, the inventors have arrived at the findings given below.

FIG. 11 is an explanatory view schematically showing a high-pressure processing system including a high-pressure processing apparatus. The high-pressure processing apparatus 1 includes a process chamber 12, in which a worktable 10 is disposed to place a wafer W thereon. The worktable 10 is provided with a heater 11 built therein to heat the wafer W. According to this system, a Cu film is formed on the surface of the wafer W, while a process fluid containing carbon dioxide in a supercritical state, a precursor, and an additive (reducing agent) is supplied into the process chamber 12.

In this high-pressure processing apparatus 1, the process fluid is supplied at a high pressure of, e.g., 7.4 MPa into the process chamber 12. Accordingly, the process chamber 12 is made of a high-tensile material that can withstand a high pressure (a material that does not fracture due to a high tension applied thereto), such as a stainless steel.

The process chamber 12 is connected to a circulating, heating, and cooling section CHC for circulating the process fluid, which is provided with an exhaust portion EX. The circulation line of the circulating, heating, and cooling section CHC is connected to a reducing agent mixing and heating unit MHra, and a source material mixing and heating unit MHms. The reducing agent mixing and heating unit MHra is connected to a reducing agent storage tank STra. The source material mixing and heating unit MHms is connected to a metal source material storage tank STms through a metal source material pressurizer PRms. Further, The reducing agent mixing and heating unit MHra and the source material mixing and heating unit MHms are commonly connected to a medium storage tank STfm through a cooling unit CLfm and a pressurizer PRfm.

The process chamber 12 is required to have the characteristics as briefly explained below. As regards the reproducibility of film formation among wafers W, the inner wall of the process chamber 12 in contact with the process fluid is preferably maintained at a constant temperature of 31 to 130° C., such as 70° C. As regards the planar uniformity of film formation on a wafer W, the inner wall of the process chamber 12 in contact with the process fluid preferably has an even and uniform temperature with a temperature difference of, e.g., less than ±5° C. on the inner wall. The temperature of the inner wall of the process chamber 12 is determined in light of the supercritical state of the process fluid, the state of a precursor dissolved in the process fluid, the flow of the process fluid within the process chamber 12, the heat amount applied to the wafer W, and so forth.

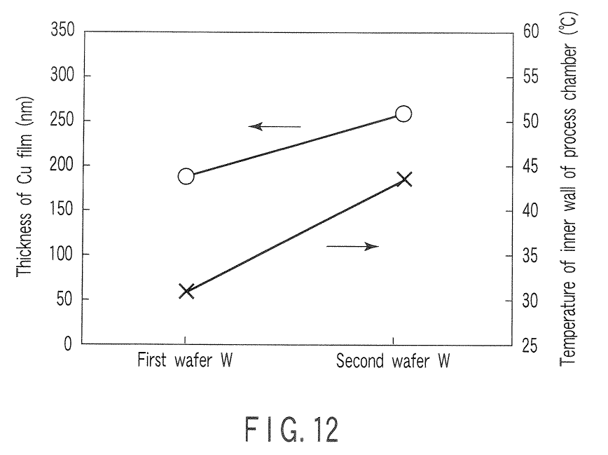

FIG. 12 is a graph showing the relationship between the temperature of the inner wall of a process chamber and the thickness of a Cu film formed on the surface of a wafer, obtained by an experiment. In FIG. 12, the symbol “O” denotes the thickness of a Cu film, and the symbol “X” denotes the temperature of the inner wall of the process chamber 12. As shown in FIG. 12, a difference in the temperature of the inner wall of the process chamber 12 brings about a difference in the thickness of a Cu film formed on the surface of a wafer W. Accordingly, the temperature of the inner wall of the process chamber 12 is preferably less fluctuated.

The temperature of the inner wall of the process chamber 12 is disturbed mainly by the following three factors. The first one is a temperature variation due to loading and unloading of a wafer W. Whether a wafer W is placed on the worktable 10 or not influences the radiation heat amount from the worktable 10, and thus the heat amount applied to the inner wall (particularly the ceiling portion) of the process chamber 12 also varies. The second one is a temperature variation of the process atmosphere due to supply and exhaust of the process fluid. In general, high-pressure processing apparatuses are arranged to supply a process fluid having a higher density and a larger thermal capacity, as compared to ordinary vacuum CVD apparatuses. Where the temperature of a supplied process fluid substantially differs from the temperature of the inner wall of the process chamber 12, the temperature of the inner wall varies prominently. The third one is a variation in the reflection coefficient of the inner wall of the process chamber 12 due to repetition of a film formation process. With repetition of a film formation process, films and/or powder are deposited on the inner wall of the process chamber 12 and change the reflection coefficient of the inner wall. Even where the radiation heat amount from the worktable 10 is the same, the temperature of the inner wall varies with a variation in the reflection coefficient of the inner wall. The first and second disturbance factors occur with a relatively high frequency (for example, every time a wafer W is processed), while the third disturbance factor occurs with a relatively low frequency (for example, every time 100 wafers W are processed).

In general, stainless steels used as the material of process chambers have a low thermal conductivity (16.5 W/mK at 100° C.). Accordingly, where the process chamber 12 is made of a stainless steel, the temperature of the inner wall shows a low response to a variation in the temperature of the process atmosphere, and thus the temperature of the inner wall can be easily uneven. Consequently, the temperature of the process atmosphere becomes unstable, and makes it difficult to uniformize the thickness of a film formed on a wafer W.

Unevenness in the temperature of the inner wall of the process chamber 12 has a further effect on the distribution of films and/or powder to be deposited on the inner wall. Accordingly, the reflection coefficient of the inner wall inevitably also becomes uneven and further deteriorates the uniformity in the temperature of the inner wall; which is a vicious cycle.

The process chamber 12 only requires the temperature of the inner surface to be controlled, and does not require the outer surface to have the same temperature. Where the process chamber 12 is made of a stainless steel, it has a very large thermal capacity. In this case, if temperature adjusting means, such as a heater and/or a chiller, is arranged to control the temperature of the entire process chamber 12, the temperature adjusting means needs to have a very large control capability. Accordingly, temperature control for the entire process chamber 12 increases the power consumption and thus increases the running costs.

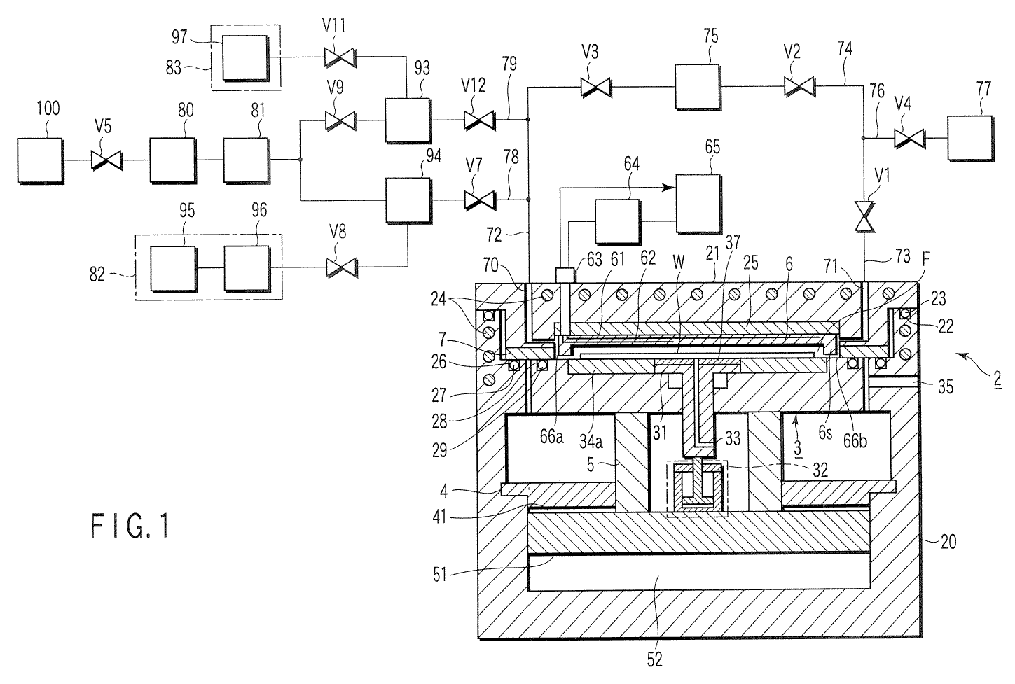

Jpn. Pat. Appln. KOKAI Publication No. 2003-71394 (FIG. 1, paragraph number 0067, and paragraph number 0068: Patent Document 2) discloses a high-pressure processing apparatus including a high-pressure processing section of the dual structure type, which is formed of an inner chamber and an outer chamber. The inner chamber has an inner wall made of a non-metal material and is arranged to accommodate a target substrate therein. The outer chamber is made of a pressure tight material and surrounds the inner chamber with a predetermined gap therebetween. This apparatus is conceived to prevent the process chamber from fracturing due to a large pressure difference caused therein when a process fluid in a supercritical state is supplied into the process chamber. Accordingly, this apparatus cannot solve the problem concerning temperature control described above.

Embodiments of the present invention achieved on the basis of the findings given above will now be described with reference to the accompanying drawings. In the following description, the constituent elements having substantially the same function and arrangement are denoted by the same reference numerals, and a repetitive description will be made only when necessary.

FIG. 1 is a sectional view showing a high-pressure processing apparatus according to a first embodiment of the present invention. This high-pressure processing apparatus includes a pressure tight container 2 configured to withstand a high pressure. The pressure tight container 2 comprises a pressure tight frame 20 that defines the side and bottom, and a top lid 21 that closes the top opening of the pressure tight frame 20. The pressure tight container 2 is provided with a worktable 3 to place a target substrate or wafer W thereon. The side of the pressure tight frame 20 has a transfer port 35 used for loading and unloading a wafer W to and from the pressure tight container 2. The pressure tight frame 20, top lid 21, and worktable 3 are made of a stainless steel (an austenitic stainless steel in accordance with SUS304 or SUS316 in JIS standard (TYPE 304 or TYPE 316 of A240 in ASTM standard)) that withstands a pressure for holding a process fluid in a supercritical state, as described later. This stainless steel has a thermal conductivity of 16.5 W/mK at 100° C. Other than a stainless steel, these members may be made of, e.g., carbon steel, titanium, Hastelloy (a registered trademark of Hanes International Ltd. in the U.S.), and Inconel (a registered trademark of Inco Ltd. in Canada).

The pressure tight frame 20 has a ring groove 22 formed therein at a position where the top face of the pressure tight frame 20 comes into contact with the bottom face of the top lid 21. An O-ring 23 is put in the ring groove 22 to ensure that the portion between the pressure tight frame 20 and top lid 21 is airtight. Each of the pressure tight frame 20 and top lid 21 has a coolant passage 24 formed therein for a coolant to flow therethrough from a chiller unit (not shown). A sealing plate 4 is disposed below the worktable 3 to separate a piston described later from the atmosphere.

The worktable 3 is connected to a piston body 51 through a piston neck 5 penetrating the sealing plate 4. A liquid pressure cavity 52 is formed below the piston body 51. The liquid pressure cavity 52 is connected to a liquid fluid system (not shown). The liquid fluid system is arranged to adjust the amount of liquid supplied into the liquid pressure cavity 52. A gas pressure cavity 41 is formed between the sealing plate 4 and piston body 51. The gas pressure cavity 41 is connected to a gas fluid system (not shown). The gas fluid system is arranged to adjust the amount of gas supplied into the gas pressure cavity 41. In this way, according to this apparatus, the amount of liquid supplied into the liquid pressure cavity 52 and the amount of gas supplied into the gas pressure cavity 41 are adjusted to move the piston body 51 up and down. Along with the piston body 51 being moved up and down, the worktable 3 is moved up and down.

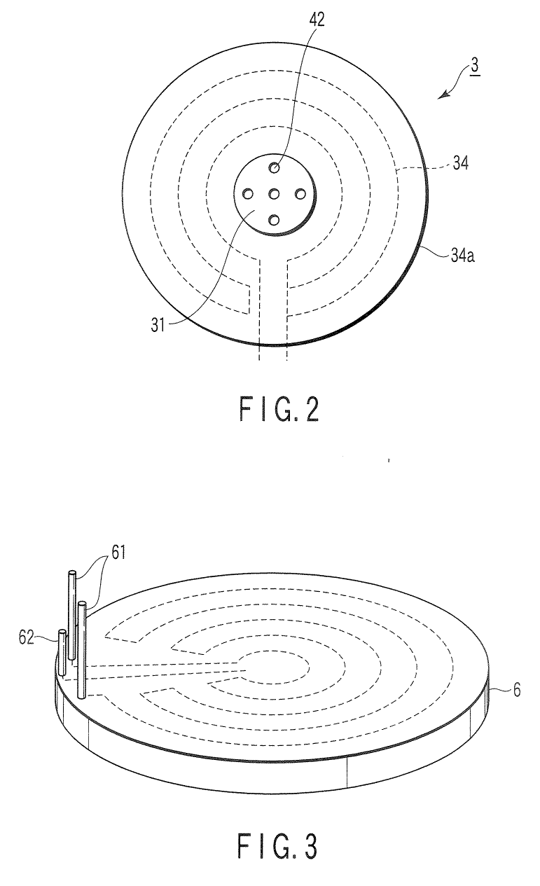

FIG. 2 is a plan view schematically showing the worktable 3 used in the high-pressure processing apparatus shown in FIG. 1. The worktable 3 includes at the center a pedestal 31 having a mushroom shape (a T-shape in the sectional side view). The bottom end of the pedestal 31 is connected to a pneumatic cylinder 32. As shown in FIG. 2, the pedestal 31 has at the top a vacuum chuck layer 37, in which a number of suction holes 42 are formed and connected to a vacuum port 33. It should be noted that FIG. 1 does not show the vacuum chuck layer 37. In place of the vacuum chuck, an electrostatic chuck may be used to hold the wafer by an electrostatic attraction force. Further, in place of the pedestal 31, a wafer lifting mechanism using lifter pins commonly used in semiconductor manufacturing apparatuses may be employed to support the wafer at three points. The pneumatic cylinder 32 is located at the bottom of the center in the bore of the piston neck 5. The pneumatic cylinder 32 is used to move the pedestal 31 up and down. As shown in FIG. 2, the worktable 3 includes at the top a heater stage 34a with heating means or a heater 34 built therein and formed of a resistance heating body. The heater 34 is connected to a power supply (not shown).

The inner wall (the upper surface and side surface) surrounding a space above the worktable 3 is provided with a thermally shielding layer 6. In the space above the worktable 3, the portion other than the heater stage 34a is covered with the thermally shielding layer 6. Specifically, in the cylindrical space above the worktable 3, a heat insulating layer 25 is attached on the upper surface of the inner wall of the pressure tight container 2. The thermally shielding layer 6 is fitted below the heat insulating layer 25 and formed of a compressed cylindrical body having a closed top and an opened bottom. Accordingly, the thermally shielding layer 6 covers the bottom surface of the heat insulating layer 25 and the side surface of the inner wall of the pressure tight container 2. A film formation process field F is defined between the thermally shielding layer 6 and heater stage 34a and encloses the process atmosphere.

In other words, the thermally shielding layer 6 is disposed to face the wafer W supported by the worktable 3 over the entire target surface (to be processed) of the wafer W. The thermally shielding layer 6 is disposed to cover the substantial entirety of the upper inner surface of the pressure tight container 2. The thermally shielding layer 6 includes a sidewall portion 6s extending downward from the entire periphery thereof to cover the side surface of the pressure tight container 2. The bottom end of the sidewall portion 6s is set to reach the floor of the film formation process field F or to face the floor with a small gap interposed therebetween. A process fluid described later flows through an opening located at the bottom end of the sidewall portion 6s (an opening formed in the bottom end or the gap between the bottom end and floor), and is then supplied onto the wafer W supported by the worktable 3.

The thermally shielding layer 6 is made of a material having a thermal conductivity higher than that of the pressure tight container 2. The heat insulating layer 25 is made of a material having a thermal conductivity lower than that of the pressure tight container 2. For example, the pressure tight container 2 is made of a material having a thermal conductivity of 10 to 100 W/mK, and typically of 11 to 50 W/mK, at 100° C. The heat insulating layer 25 is made of a material having a thermal conductivity of lower than 10 W/mK, and typically of lower than 5 W/mK, at 100° C. On the other hand, the thermally shielding layer 6 is made of a material having a thermal conductivity of higher than 100 W/mK, and preferably of 150 to 450 W/mK, at 100° C. For example, the thermally shielding layer 6 is made of a material selected from the group consisting of aluminum, copper, molybdenum, tungsten, aluminum nitride, and silicon carbide, or a material containing at least one of them as the main component (it means 50% or more).

Aluminum (Al) has a fairly high thermal conductivity of 240 W/mK at 100° C., and thus is suitable for the material of the thermally shielding layer 6. Copper (Cu) has a thermal conductivity of 395 W/mK at 100° C. Molybdenum (Mo) has a thermal conductivity of 134 W/mK at 100° C. Tungsten (W) has a thermal conductivity of 159 W/mK at 100° C. Nitride aluminum (AlN) has a thermal conductivity of 100 to 280 W/mK at 100° C. Silicon carbide (SiC) has a thermal conductivity of 100 to 300 W/mK at 100° C. Further, as described above, a compound of some of these materials or an alloy containing some of these materials as the main component (50% or more) may be used. The thickness of the thermally shielding layer 6 is preferably set to be 0.5 mm to 5 cm, for example. If the thickness of the thermally shielding layer 6 is insufficient, the thermal storage function becomes essentially insufficient. If the thickness is excessive, the response relative to a temperature variation becomes insufficient.

The heat insulating layer 25 is arranged to thermally isolate the pressure tight container 2 from the thermally shielding layer 6. Accordingly, the heat insulating layer 25 is made of a material having a thermal conductivity lower than that of the pressure tight container 2, such as quartz (quartz glass, which has a thermal conductivity of 1.9 W/mK at 100° C.). In place of quartz glass, the heat insulating layer 25 may be made of a material selected from the group consisting of a silicate, such as mulite or cordierite, a ceramic, such as partially stabilized zirconia, and an engineering plastic, such as polyimide.

FIG. 3 is a perspective view schematically showing the thermally shielding layer 6 used in the high-pressure processing apparatus shown in FIG. 1. As shown in FIG. 3, the thermally shielding layer 6 is provided with a spiral sheathe heater 61 used as temperature adjusting means and a thermocouple 62 used as temperature detecting means, which are built therein. As shown in FIG. 1, the top lid 21 includes at the top a sealing ground 63 for isolating the high pressure atmosphere from an atmospheric pressure atmosphere. The sheathe heater 61 and thermocouple 62 are respectively connected to a power supply 64 and a temperature controller 65 through the sealing ground 63. The temperature controller 65 is arranged to control the power supplied to the sheathe heater 61 on the basis of values of temperature detected by the thermocouple 62. As described above, the sheathe heater 61 and thermocouple 62 are built in the thermally shielding layer 6 to control heating of the thermally shielding layer 6. The temperature adjusting means built in the thermally shielding layer 6 may include a Peltier element in place of or in addition to the sheathe heater 61. Further, for example, a resistance temperature sensor may be used as temperature detecting means, in place of the thermocouple 62.

A spacer 7 is interposed between the bottom face of the top lid 21 and the top face of the pressure tight frame 20. The pressure tight frame 20 has a ring groove 26 formed therein at a position where the top face of the pressure tight frame 20 comes into contact with the bottom face of the spacer 7. An O-ring 27 is put in the ring groove 26 to ensure that the portion between the pressure tight frame 20 and spacer 7 is airtight. The worktable 3 has a ring groove 28 formed therein at a position where the top face of the worktable 3 comes into contact with the bottom face of the spacer 7. An O-ring 29 is put in the ring groove 28 to ensure that the portion between the worktable 3 and spacer 7 is airtight.

As shown in FIG. 1, a supply passage 70 and an exhaust passage 71 are formed in the top lid 21 to communicate with the film formation process field F surrounded by the top lid 21 and worktable 3. The supply passage 70 is used to supply a process fluid containing a supercritical fluid used as a medium and a film formation source material. The exhaust passage 71 is used to exhaust the process fluid from the film formation process field F. The thermally shielding layer 6 is arranged to form, between the outer end thereof and the top lid 21, slit-like gaps 66a and 66b which communicate with the supply passage 70 and exhaust passage 71, respectively. The process fluid flows from the supply passage 70 through the gap 66a into the film formation process field F. Then, the process fluid flows from one side of the wafer W to the other side thereof (from left to right in FIG. 1). Then, the process fluid is exhausted from the process field F through the gap 66b into the exhaust passage 71.

The supply passage 70 and exhaust passage 71 are respectively connected to a supply line 72 and an exhaust line 73, so that they form a circulation passage 74. The circulation passage 74 is provided with exhaust valves V1 and V2, a circulating, heating, and cooling section 75, and a valve V3 in this order from the exhaust line 73 side.

A portion of the exhaust line 73 between the exhaust valves V1 and V2 is connected to an exhaust portion 77 through a branch line 76 provided with a back pressure regulating valve V4. The exhaust portion 77 includes a separation and collection unit, a collection valve, a liquid collection portion, and a gas exhaust portion (all of them are not shown), and further includes a vacuum pump (not shown), as needed.

The supply line 72 is connected to a branch line 78 and a branch line 79. The branch line 78 is connected to a source material mixing and heating unit 94 and a feed valve V7. The branch line 79 is connected to a reducing agent mixing and heating unit 93 and a feed valve V12.

The source material mixing and heating unit 94 is connected to a precursor supply section 82 through a valve V8. The precursor supply section 82 includes a metal source material storage tank 95 storing a film formation source material and a metal source material pressurizer 96. For example, the film formation source material is a precursor consisting of an organic complex compound containing Cu (precursor compound), such as Cu²⁺(hfac)₂. The reducing agent mixing and heating unit 93 is connected to a reducing agent supply section 83 through a valve V11. The reducing agent supply section 83 includes a reducing agent storage tank 97 storing a reducing agent, such as hydrogen (H₂).

Further, the reducing agent mixing and heating unit 93 and the source material mixing and heating unit 94 are connected to a medium storage tank 100 storing carbon dioxide (CO₂), through a supply source valve V5, a cooling unit 80, and a pressurizer 81 in this order from the upstream side. For example, the medium storage tank 100 is formed of a carbon dioxide cylinder. The lines and valves downstream from the pressurizer 81 to the exhaust portion 77 are wrapped with a heater and/or a thermal insulator to attain suitable temperature control. With this arrangement, a medium, such as carbon dioxide, and/or a process fluid, such as carbon dioxide containing a source material dissolved therein, are kept at a temperature of higher than 30° C., such as 40° C., to maintain a supercritical state. Further, the temperature of the process fluid flowing through the lines is prevented from largely fluctuating.

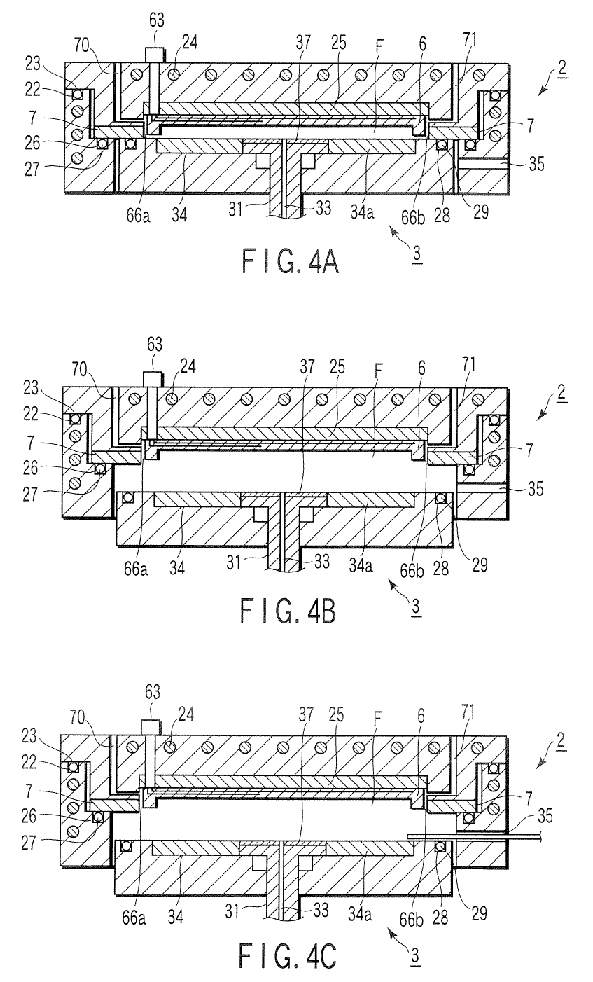

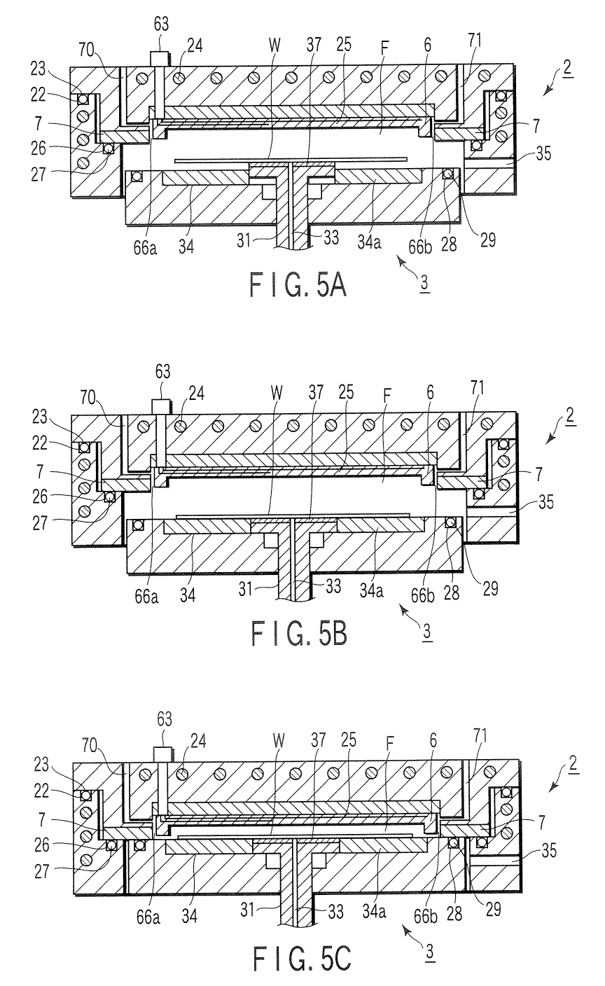

Next, an explanation will be given of an operation performed in the high-pressure processing apparatus described above, leading up to a time when a wafer W is placed on the worktable 3 inside the pressure tight container 2. FIGS. 4A, 4B, and 4C and FIGS. 5A, 5B, and 5C are sectional views showing sequentially ordered steps of a process performed in the high-pressure processing apparatus shown in FIG. 1.

In FIG. 4A, the worktable 3 is set in a closed position where the worktable 3 is in close contact with the spacer 7 through the O-ring 29, and the film formation process field F surrounded by the top lid 21 and worktable 3 is empty. From this state, at first, as shown in FIG. 4B, the worktable 3 is moved down to a load position by the piston body 51. Thereafter, as shown in FIG. 4C, a target substrate or wafer W is loaded by a transfer arm (not shown) from a load-lock chamber having a vacuum atmosphere through the transfer port 35 into the pressure tight container 2.

Subsequently, as shown in FIG. 5A, the pedestal 31 is moved by the pneumatic cylinder 32 so that the wafer W is lifted and separated from the transfer arm (not shown). Then, the transfer arm is retreated from the pressure tight container 2. When the wafer W is lifted and separated from the transfer arm by the pedestal 31, the wafer W is attracted and held on the pedestal 31 by vacuum suction of the vacuum chuck layer 37. Subsequently, as shown in FIG. 5B, the pedestal 31 is moved down by the pneumatic cylinder 32, so that the wafer W is placed on the worktable 3. Thereafter, as shown in FIG. 5C, the worktable 3 is moved up by the piston body 51, so that the worktable 3 comes into close contact with the spacer 7 through the O-ring 29.

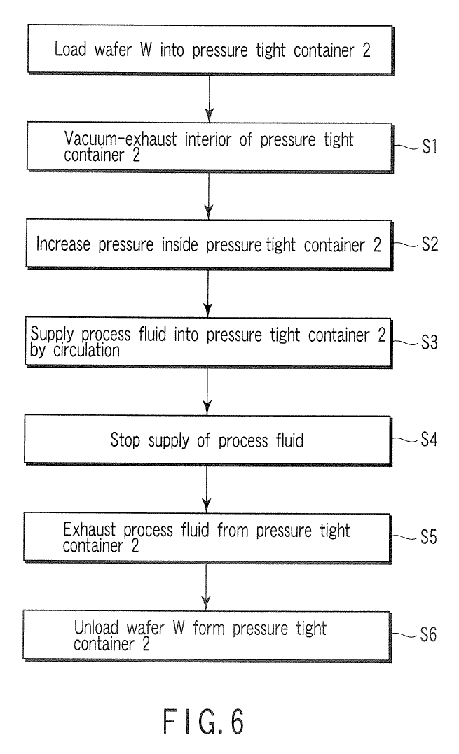

Next, an explanation will be given of sequentially ordered steps of a process performed in the high-pressure processing apparatus shown in FIG. 1, with reference to FIG. 6. FIG. 6 is a flowchart showing sequentially ordered steps of this process performed in the high-pressure processing apparatus shown in FIG. 1.

At first, the interior of the pressure tight container 2 is vacuum-exhausted by the exhaust portion 77 (Step S1). On the other hand, the heater 34 built in the worktable 3 is set in an ON-state in advance, to heat the surface of the worktable 3 to a temperature of e.g., 200 to 350° C., and preferably of 250 to 3000° C. Further, the sheathe heater 61 built in the thermally shielding layer 6 is controlled to be maintained at a temperature of e.g., 70C. Then, the supply source valve V5 and feed valve V7 are opened to supply a medium (carbon dioxide) heated to a predetermined temperature of, e.g., 40° C. into the pressure tight container 2 through the source material mixing and heating unit 94. Consequently, the pressure inside the pressure tight container 2 is increased to a value close to the pressure inside the medium storage tank 100. Then, carbon dioxide is supplied from the medium storage tank 100 through the cooling unit 80, and is pressurized by the pressurizer 81 to a value higher than the pressure inside the medium storage tank 100. The carbon dioxide thus pressurized is supplied into the pressure tight container 2. Also in this case, the carbon dioxide is supplied through the source material mixing and heating unit 94 and is thereby maintained at a predetermined temperature. In this way, the interior of the pressure tight container 2 is pressurized to a predetermined process pressure of, e.g., 15 MPa to obtain carbon dioxide in a supercritical state (supercritical fluid). At this time, the exhaust valve V1 is opened, and a predetermined pressure is maintained by the pressure control provided by the back pressure regulating valve V4 (Step S2).

This process is an example in which carbon dioxide set at a pressure higher than the pressure inside the medium storage tank 100 is supplied into the pressure tight container 2, and thus the medium storage tank 100 is provided with the pressurizer 81. Alternatively, where carbon dioxide supplied from a tank is higher than a process pressure, a pressure reducing valve may be used in place of the cooling unit 80 and pressurizer 81 between the tank and the source material mixing and heating unit 94.

Immediately after the metal source material pressurizer 96 is activated, the valve V8 is opened to supply a liquefied metal source material into the source material mixing and heating unit 94. In this unit 94, the metal source material is mixed into the supercritical carbon dioxide supplied through the cooling unit 80 and pressurizer 81 and thus has a predetermined pressure. Consequently, a process fluid is prepared such that it contains the supercritical fluid mixed with the metal source material and is set at a predetermined temperature of, e.g., 40° C. This process fluid may be continuously supplied through the feed valve V7 into the pressure tight container 2, while the pressurizer 81 and metal source material pressurizer 96 are set in a continuous run. The liquefied metal source material may be prepared by dissolving a precursor, such as Cu²⁺(hfac)₂ into an organic solvent, such as alcohol.

Where a gaseous reducing agent, such as H₂ as in this embodiment, is mixed, the reducing agent is adjusted to have a predetermined pressure of, e.g., 0.9 MPa. Then, the reducing agent is supplied into the reducing agent mixing and heating unit 93, and is mixed with the supercritical carbon dioxide to produce a process fluid. This process fluid is supplied through the feed valve V12 into the pressure tight container 2 (Step S3). A liquefied reducing agent, such as alcohol, may be used to produce a process fluid, while it is pressurized and mixed in the same manner used for the liquefied metal source material.

The process fluid flows through the supply passage 70 and the supply-side gap 66a, further flows through an opening located at the bottom end of the sidewall portion 6s of the thermally shielding layer 6 (an opening formed in the bottom end or the gap between the bottom end and floor), and enters the film formation process field F. Then, the process fluid flows from one side of the wafer W to the other side thereof (from left to right in FIG. 1). Then, the process fluid is exhausted from the process field F through the exhaust-side gap 66b into the exhaust passage 71. This process fluid is circulated by the circulating, heating, and cooling section 75 with the valves V2 and V3 set in an opened state, and a film formation process is performed for a predetermined time period. At this time, the precursor is thermally decomposed on the surface of the wafer W placed on the worktable 3 in accordance with a reaction shown in the flowing formula (1).

Consequently, a Cu film is formed on the surface of the wafer W.
Cu²⁺(hfac)₂+H₂→Cu+2H(hfac) (1)

After a Cu film is formed on the wafer W, the valves V2 and V3, feed valve V7, and feed valve V12 are closed to stop supply of the process fluid. As regards the metal source material, the valve V8 is closed, and the metal source material pressurizer 96 is stopped, to stop mixing thereof into the process fluid. Similarly, as regards the reducing agent, the valves V9 and V11 are closed to stop mixing thereof into the process medium (Step S4).

Thereafter, the exhaust valve V1 is opened, and the back pressure regulating valve V4 is set in an opened state by decreasing the set pressure, to exhaust the process fluid from the pressure tight container 2 by the exhaust portion 77 (Step S5). In the exhaust portion 77, carbon dioxide is exhausted from a gas exhaust portion. Further, where a unit for separating, refining, and condensing carbon dioxide is disposed downstream from the gas exhaust portion, carbon dioxide can be recycled. Then, the wafer W is unloaded from the pressure tight container 2 to the load-lock chamber (not shown) having a vacuum atmosphere, by means of an operation reverse to the sequential operation for loading the wafer W onto the worktable 3 inside the pressure tight container 2 (Step S6). Thereafter, a subsequent wafer W is subjected to a film formation process in the same manner.

According to the embodiment described above, the pressure tight container 2 is made of a stainless steel that can withstand a pressure for maintaining the supercritical fluid, and a thermally shielding layer 6 is attached on the inner surface of the pressure tight container 2. Since the thermally shielding layer 6 is not required to serve for maintaining a high pressure, the material thereof does not have to be a high-tensile material, such as a stainless steel. Accordingly, the material of the thermally shielding layer 6 can be selected from a wide range of materials having a high thermal conductivity. Further, the thickness of the thermally shielding layer 6 can be also arbitrarily determined. For example, the thermally shielding layer 6 may be made of aluminum or copper that has a higher thermal conductivity than the material of the pressure tight container 2. Consequently, the temperature of the portion in contact with the process fluid inside the pressure tight container 2 (i.e., the inner wall of a process chamber) is prevented from becoming uneven. It follows that, the temperature inside the film formation process field F becomes stable, so a film can be formed on a wafer W with high uniformity in the thickness. Further, the sheathe heater 61 used as temperature adjusting means is required only to control the temperature of the thermally shielding layer 6 as a control target, and not required to control the temperature of the entire pressure tight container 2. Accordingly, the necessary performance of the temperature adjusting means is small, which decreases the power consumption and thus decreases the running cost.

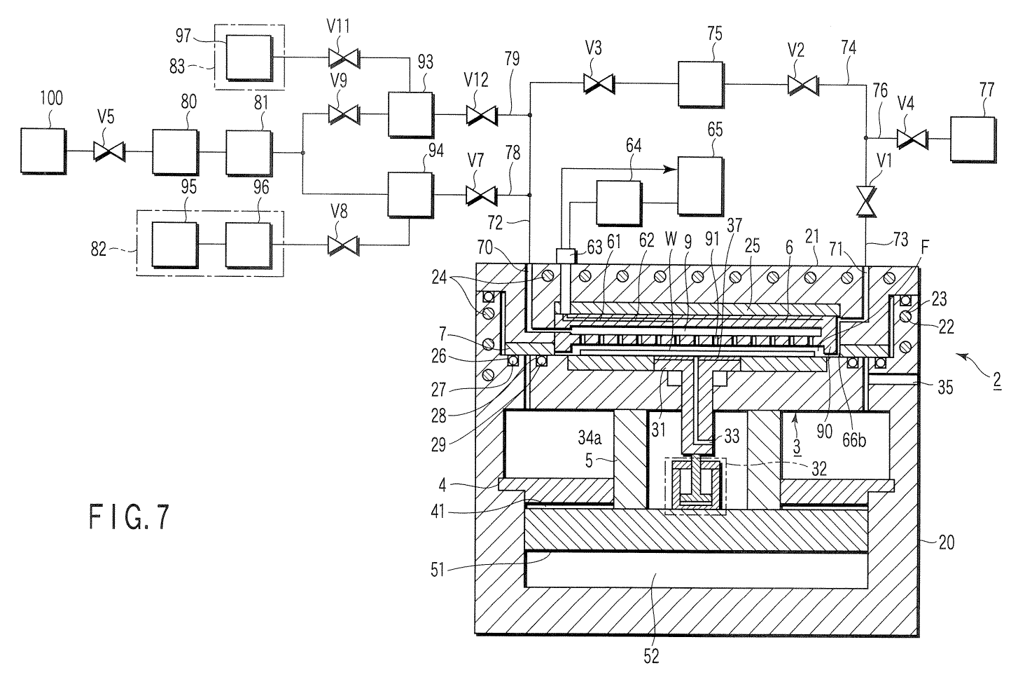

FIG. 7 is a sectional view showing a high-pressure processing apparatus according to a second embodiment of the present invention. As shown in FIG. 7, this high-pressure processing apparatus includes a showerhead 90 used as a thermally shielding layer located in close contact with the bottom face of a top lid 21 (above the worktable 3) through a heat insulating layer 25. The remaining structure of the high-pressure processing apparatus shown in FIG. 7 is the same as that of the high-pressure processing apparatus shown in FIG. 1.

As shown in FIG. 7, at least the lowermost layer of the showerhead 90 serves as a thermally shielding layer that is fitted in the space above the worktable 3, as in the first embodiment. However, a distribution space (fluid supply head) 9 is formed behind this thermally shielding layer. Further, this thermally shielding layer has a number of spouting holes 91 formed therein, which face a wafer W placed on the worktable 3 and communicate with the distribution space 9. A supply passage 70 is formed in the pressure tight container 2 and is connected to the distribution space 9.

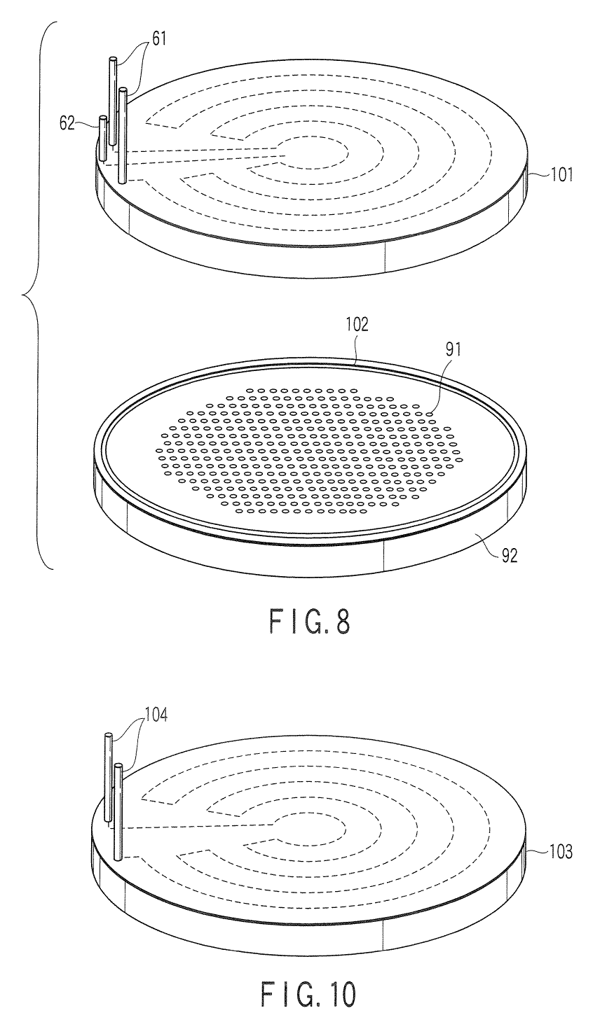

FIG. 8 is a perspective and exploded view schematically showing the showerhead 90 used in the high-pressure processing apparatus shown in FIG. 7. As shown in FIG. 8, the showerhead 90 is formed of a lower member 92 and an upper member 101, which are vertically separable from each other, wherein the distribution space 9 serves as the boundary therebetween. The lower member 92 has a ring groove 102 formed therein at the top face. An O-ring (not shown) is put in the ring groove 102 to ensure that the portion between the upper member 101 and lower member 92 is airtight. The upper member 101 is provided with a sheathe heater 61 and a thermocouple 62 built therein.

According to the second embodiment, a process fluid is supplied through the supply passage 70 into the distribution space 9, and is then spouted downward from the spouting holes 91 formed in the surface portion of the showerhead 90. The process fluid thus supplied flows through the film formation process field F and is then exhausted through a gap 66b into an exhaust passage 71. With this arrangement, the process fluid is supplied uniformly onto the wafer W placed on the worktable 3.

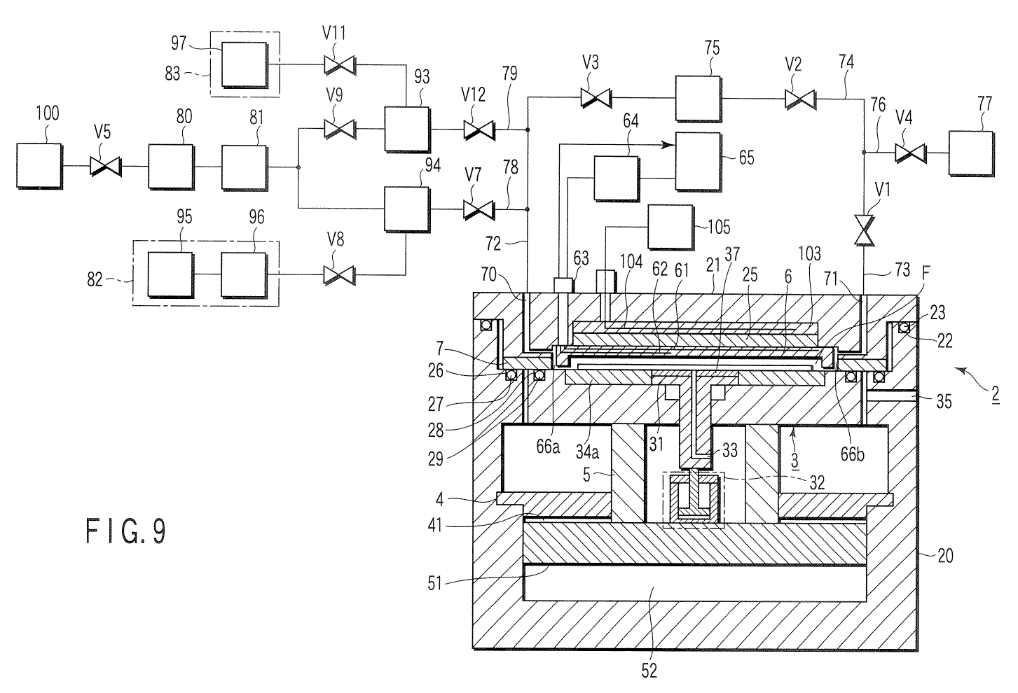

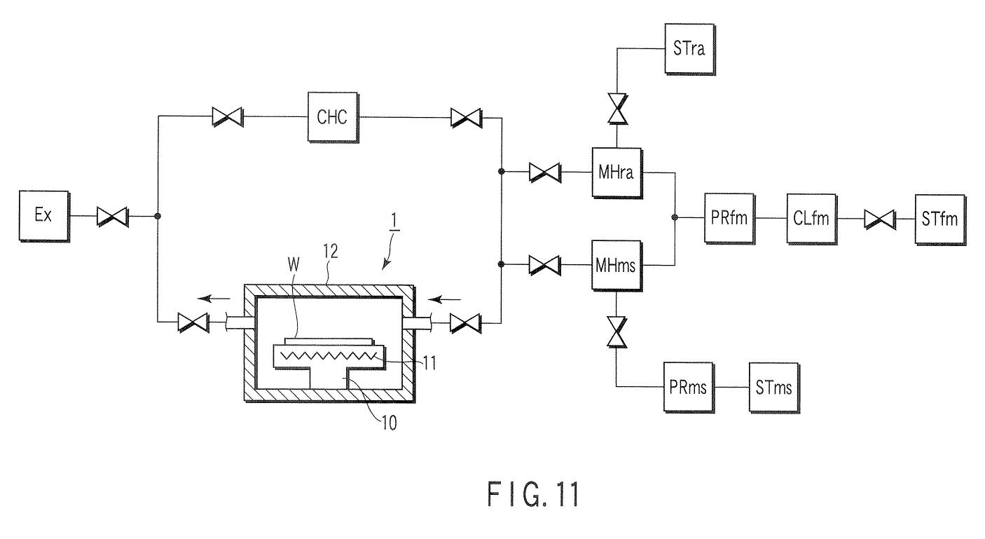

FIG. 9 is a sectional view showing a high-pressure processing apparatus according to a third embodiment of the present invention. As shown in FIG. 9, this high-pressure processing apparatus includes a heat sink layer 103 provided on the inner upper surface of a top lid 21, made of a stainless steel, and used as cooling means. A heat insulating layer 25 is stacked on the bottom of the heat sink layer 103. The remaining structure of the high-pressure processing apparatus shown in FIG. 9 is the same as that of the high-pressure processing apparatus shown in FIG. 1.

FIG. 10 is a perspective view schematically showing the heat sink layer 103 used in the high-pressure processing apparatus shown in FIG. 9. As shown in FIG. 10, the heat sink layer 103 is provided with a spiral coolant pipe 104 made of a stainless steel and built therein. The coolant pipe 104 is connected to a chiller unit 105. A coolant (set at a temperature of, e.g., about 40 to 90° C.), such as Galden (a registered trademark of Solvary Solexis, Inc. in Italy), or Fluorinert (a registered trademark of 3M Ltd. in the U.S.), is supplied from the chiller unit 105 into the coolant pipe 104, to cool down the heat insulating layer 25 that has stored heat.

As cooling means provided at the heat sink layer 103, a heat pipe may be used in place of the coolant pipe 104. In general, a heat pipe is structured such that the both ends are closed, and a porous body made of, e.g., metal or metal felt, is attached on the inner wall. A small amount of volatile liquid (operation fluid) is enclosed in the metal tube (heat pipe) set in a vacuum state. When one end of the heat pipe is heated, the operation fluid is vaporized and is thereby moved to the other end. Then, the operation fluid is returned through the porous body, thereby transferring heat.

Such a heat pipe may be applied to the heat sink layer 103, as follows. For example, the heat sink layer 103 may be provided with a spiral heat pipe built therein similarly to the coolant pipe, or provided with a plurality of linear heat pipes arrayed in parallel. The other end side (condensation side) of the heat pipe or pipes is lead out of the heat sink layer 103, and is set in contact with a cooling portion, such a cooling plate configured to be cooled by, e.g., a cooling medium. Consequently, heat stored in the heat insulating layer 25 is discharged through the heat pipe into the cooling portion, so the heat insulating layer 25 is cooled.

According to the third embodiment, the effect of thermally isolating the thermally shielding layer 6 from the pressure tight container 2 is enhanced, so the temperature inside the film formation process field F is more stable.

Each of the first to third embodiments is applied to a high-pressure processing apparatus, in which a medium formed of a high-pressure fluid in a supercritical state is mixed with a film formation source material outside a pressure tight container to produce a process fluid. Alternatively, a high-pressure processing apparatus may be arranged such that a medium set at a non-high pressure is supplied into a pressure tight container, and is then changed to a high-pressure fluid (e.g., in supercritical state) inside the container. In this case, the medium may be mixed with a film formation source material outside the pressure tight container or inside the container. A technique of this kind is disclosed in U.S. Pat. Pub. No. US 2006/0084266 A1, the teachings of which are hereby incorporated by reference.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A high-pressure processing apparatus for performing a film formation process on a target object, while using a process fluid containing a high-pressure fluid and a film formation source material, the apparatus comprising:
a pressure tight container defining a process field for accommodating the target object, and configured to withstand a pressure applied from the high-pressure fluid, the pressure tight container being made of a first material;
a support member disposed inside the pressure tight container to support the target object;
a fluid supply system configured to supply the process fluid onto the target object; and
a thermally shielding layer disposed to cover a surface of the pressure tight container defining the process field, the thermally shielding layer being made of a second material having a thermal conductivity higher than that of the first material.

2. The apparatus according to claim 1, wherein the fluid supply system is configured to supply a supercritical fluid as the high-pressure fluid.

3. The apparatus according to claim 1, wherein the second material contains as a main component a material selected from the group consisting of aluminum, copper, molybdenum, tungsten, nitride aluminum, and silicon carbide.

4. The apparatus according to claim 1, wherein the apparatus further comprises a temperature adjusting mechanism configured to adjust a temperature of the thermally shielding layer.

5. The apparatus according to claim 4, wherein the temperature adjusting mechanism comprises a temperature sensor and at least one of a heater and a cooler to be controlled with reference to a result detected by the temperature sensor.

6. The apparatus according to claim 1, wherein the apparatus further comprises a heat insulating layer interposed between the thermally shielding layer and the inner wall of the pressure tight container, and the heat insulating layer is made of a third material having a thermal conductivity lower than that of the first material.

7. The apparatus according to claim 6, wherein the apparatus further comprises a cooler interposed between the heat insulating layer and the pressure tight container.

8. The apparatus according to claim 1, wherein the thermally shielding layer is disposed to face the target object supported by the support member over an entire surface thereof to be processed.

9. The apparatus according to claim 1, wherein the thermally shielding layer is disposed to cover substantially entirely an upper inner surface of the pressure tight container.

10. The apparatus according to claim 9, wherein the thermally shielding layer includes a sidewall portion extending downward from an entire periphery thereof to cover a side surface of the pressure tight container.

11. The apparatus according to claim 10, wherein the sidewall portion has a bottom end set to substantially reach a floor of the film formation process.

12. The apparatus according to claim 10, wherein the fluid supply system is arranged such that the process fluid flows through an opening located at a bottom end of the sidewall portion and is then supplied onto the target object supported by the support member.

13. The apparatus according to claim 9, wherein the fluid supply system comprises a fluid supply head formed behind the thermally shielding layer, and a plurality of spouting holes formed in the thermally shielding layer and communicating with the fluid supply head.

14. The apparatus according to claim 1, wherein the second material has a thermal conductivity of higher than 100 W/mK at 100° C.

15. The apparatus according to claim 6, wherein the third material has a thermal conductivity of lower than 10 W/mK at 100° C.

16. The apparatus according to claim 1, wherein the first material has a thermal conductivity of 10 to 100 W/mK at 100° C.

17. A high-pressure processing apparatus for performing a film formation process on a target object, while using a process fluid containing a high-pressure fluid and a film formation source material, the apparatus comprising:
a pressure tight container defining a process field for accommodating the target object, and configured to withstand a pressure applied from the high-pressure fluid, the pressure tight container being made of a first material having a thermal conductivity of 10 to 100 W/mK at 100° C.;
a support member disposed inside the pressure tight container to support the target object;
a fluid supply system configured to supply the process fluid onto the target object; and
a thermally shielding layer disposed to cover a surface of the pressure tight container defining the process field, the thermally shielding layer being made of a second material having a thermal conductivity of higher than 100 W/mK at 100° C.,
wherein the thermally shielding layer is disposed to cover substantially entirely an upper inner surface of the pressure tight container, and includes a sidewall portion extending downward from an entire periphery thereof to cover a side surface of the pressure tight container, and
wherein the fluid supply system is arranged such that the process fluid flows through an opening located at a bottom end of the sidewall portion and is then supplied onto the target object supported by the support member.

18. The apparatus according to claim 17, wherein the fluid supply system is configured to supply a supercritical fluid as the high-pressure fluid.

19. A high-pressure processing apparatus for performing a film formation process on a target object, while using a process fluid containing a high-pressure fluid and a film formation source material, the apparatus comprising:
a pressure tight container defining a process field for accommodating the target object, and configured to withstand a pressure applied from the high-pressure fluid, the pressure tight container being made of a first material having a thermal conductivity of 10 to 100 W/mK at 100° C.;
a support member disposed inside the pressure tight container to support the target object;
a fluid supply system configured to supply the process fluid onto the target object; and
a thermally shielding layer disposed to cover a surface of the pressure tight container defining the process field, the thermally shielding layer being made of a second material having a thermal conductivity of higher than 100 W/mK at 10° C.,
wherein the thermally shielding layer is disposed to cover substantially entirely an upper inner surface of the pressure tight container, and
wherein the fluid supply system comprises a fluid supply head formed behind the thermally shielding layer, and a plurality of spouting holes formed in the thermally shielding layer and communicating with the fluid supply head.

20. The apparatus according to claim 19, wherein the fluid supply system is configured to supply a supercritical fluid as the high-pressure fluid.
